(19) United States
(12) Patent Application Publication
(10) Pub. No.: US 2010/0148600 A1
(43) Pub. Date: Jun. 17, 2010

(54) Fluid dynamic bearing system

(76) Inventors: Martin Bauer, Villingen-Schwenningen (DE); Vladimir V. Popov, Villingen-Schwenningen (DE); Guido Schmid, Triberg (DE)

Correspondence Address: COOPER & DUNHAM, LLP, 30 Rockefeller Plaza, 20th Floor, NEW YORK, NY, 10112, US

(21) Appl. No.: 12/592,979

(22) Filed: Dec. 7, 2009

(30) Foreign Application Priority Data
Dec. 17, 2008 (DE) 10 2008 062 679.1

(51) Int. Cl. H02K 9/00; F16C 32/06; H02K 7/09; H02K 5/167

(52) U.S. Cl. 310/52; 384/107; 310/90.5; 310/90

(57) ABSTRACT

The fluid dynamic bearing system according to the invention for the rotatable support of an electric motor comprises a substantially cylindrical bearing bush having a bearing bore, a shaft rotatably supported about a rotational axis accommodated in the bearing bore, a bearing gap formed between mutually adjacent surfaces of the bearing bush and the shaft that is filled with a bearing fluid and extends in an axial direction parallel to the rotational axis, at least one radial bearing that is disposed along the bearing gap and formed by bearing surfaces of the bearing bush and the shaft, and at least one axial bearing that is formed as a magnetic bearing.

### BACKGROUND OF THE INVENTION

The invention relates to a fluid dynamic bearing system for the rotatable support of an electric motor, preferably a spindle motor, as can be used, for example, for driving hard disk drives, ventilators or pumps.

### PRIOR ART

Electric motors having a fluid dynamic bearing system are known in the prior art in a large variety of designs. In particular, drive motors for hard disk drives, optical storage drives as well as ventilators have to ensure a high rotational speed at great precision and at the same time have low noise generation and allow cheap manufacture in large numbers. Over the last few years, fluid dynamic bearing systems have proven to be the primary choice when it comes to the rotatable support of these kinds of electric motors. Electric motors having fluid dynamic bearing systems are very often constructed in an extremely complicated way and are expensive to manufacture, as, for example, the spindle motor having a fluid dynamic bearing according to U.S. Pat. No. 7,015,611 B2.

Bearing systems for small scale motors of a simpler construction are also known in the prior art, for example, from U.S. Pat. No. 7,025,505 B2. The bearing system shown here can be easily and cheaply constructed, but because the axial bearing employed is subject to friction, the bearing system is not suitable for operation at high rotational speeds over a longer period of time, rotational speeds in the range of 10,000 rpm and over being applicable here, as required nowadays in such precision motors.

U.S. Pat. No. 7,008,112 B2 also discloses a bearing system having a relatively simple construction in which a fluid dynamic axial bearing is used instead of an axial bearing subject to friction, the fluid dynamic axial bearing comprising a thrust plate connected to the shaft and a bearing plate acting as a counter bearing. However, due to the relatively simple method of sealing the bearing gap in the region between the shaft and an upper covering plate, this bearing is not intended for high rotational speeds.

### SUMMARY OF THE INVENTION

It is the object of the invention to provide a fluid dynamic bearing system that can be easily and cheaply constructed but nevertheless allows operation at high rotational speeds and ensures low noise generation.

This object has been achieved according to the invention by a bearing system having the characteristics outlined in claim 1.

Preferred embodiments of the invention and further advantageous characteristics are revealed in the subordinate claims.

The fluid dynamic bearing system according to the invention for the rotatable support of an electric motor comprises a substantially cylindrical bearing bush having a bearing bore, a shaft rotatable about a rotational axis accommodated in the bearing bore, a bearing gap filled with a bearing fluid formed between mutually adjacent surfaces of the bearing bush and the shaft and extending in an axial direction parallel to the rotational axis, at least one radial bearing that is disposed along the bearing gap and formed by bearing surfaces of the bearing bush and the shaft, and at least one axial bearing that is designed as a magnetic bearing.

The bearing consists of only a few components that have a simple geometry and can thus be manufactured at low cost. The magnetic bearing forming the axial bearing makes it possible to reduce frictional forces when compared to a pure fluid dynamic bearing. This makes it possible to fit electric motors with this bearing and have them operate with less energy consumption, even at very high rotational speeds. A further advantage is that the magnetic axial bearing does not run in bearing fluid making it possible to reduce friction even further.

In a preferred embodiment of the invention, the magnetic axial bearing is disposed in axial extension of the bearing gap, i.e. approximately in line with the radial bearing, where preferably two radial bearings operated in line are used. Here, the axial bearing is preferably disposed radially outwards, i.e. on a larger diameter than the radial bearing and the bearing gap.

Preferably, the magnetic axial bearing comprises a first axial bearing part that consists of at least one permanent magnet and at least two flux conducting elements associated with the permanent magnet and that are disposed at opposing end faces of the permanent magnet and that are aligned substantially radial and perpendicular to the rotational axis. A second axial bearing part consists of at least two flux conducting elements that are disposed at a mutual distance from one another and are aligned substantially radial and perpendicular to the rotational axis. Each flux conducting element of the second axial bearing part is associated with a flux conducting element of the first axial bearing part and lies directly opposite the latter in a radial direction separated by an air gap.

In an alternative embodiment of the invention, the flux conducting elements associated with the permanent magnet within the first axial bearing part may be omitted. In this embodiment of the invention, the permanent magnet may have an appropriate shape and/or a special magnetization so that additional flux conducting elements are not necessary.

The second axial bearing part may comprise at least two flux conducting elements that are disposed at a mutual distance from one another and are aligned substantially with the permanent magnet of the first axial bearing part, or alternatively, the second axial bearing part may comprise a permanent magnet having an appropriate shape and/or a special magnetization so that additional flux conducting elements are not needed.

In a first embodiment of the invention, the axial bearing is disposed in a recess in the bearing bush that adjoins the bearing gap. Here, the second axial bearing part is disposed on a circumferential section of the shaft, the first axial bearing part being disposed in the recess in the bearing bush and radially enclosing the second axial bearing part while forming the air gap. The second axial bearing part is preferably disposed at one end of the shaft and may either be formed as a separate piece or formed integrally with the shaft as one piece. Moreover, the second axial bearing part may be formed as a stopper element of the shaft, i.e. interacting with an appropriate step in the bearing bore, thus preventing any excessive axial displacement in the shaft in the bearing bore.

In another embodiment of the invention, the second axial bearing part is disposed on a circumferential section at the outside circumference of the bearing bush. Here, the first axial bearing part is disposed in a recess in a rotor component connected to the shaft and encloses the second axial bearing part in a radial direction while forming the air gap. In this embodiment of the invention, the second axial bearing part may be formed as a separate piece or integrally formed with the bearing bush as one piece.

According to a preferred embodiment of the invention, the bearing gap has two open ends each of which is sealed by a sealing gap, the sealing gaps being disposed in axial extension of the bearing gap.

In another preferred embodiment of the invention, the bearing gap may have only one open end that is sealed by a sealing gap running in axial extension of the bearing gap. The other end of the bearing gap is sealed by the bearing bush or a component covering the bearing bush.

The sealing gaps are preferably tapered sealing gaps that form tapered capillary seals. Here, the respective sealing gap may preferably extend at an acute angle to the rotational axis. The sealing gap has an open end, the section of the sealing gap adjacent to the bearing gap having a larger diameter than the open end of the sealing gap. Consequently, on rotation of the bearing, the bearing fluid found in the sealing gap is subjected to a centrifugal force that acts radially outwards and forces the bearing fluid in the direction of the bearing gap.

Radial support for the shaft is preferably realized by two radial bearings that are disposed at a mutual distance from one another along the bearing gap. The radial bearings may be provided with familiar bearing grooves that are disposed on the bearing surface of the bearing bush and/or the shaft. However, the radial bearings may also be designed as grooveless radial bearings that have smooth bearing surfaces. Moreover, the radial bearings may be designed as segment thrust bearings or multi-face slide bearings.

The bearing system according to the invention is preferably used for the rotatable support of the rotor of an electric motor, the stationary part of the bearing system, the bearing bush for example, being connected to the stator of the motor and the rotating bearing part, preferably the shaft, being connected to the rotor of the motor. The motor is driven in a familiar way by an electromagnetic drive system.

### BRIEF DESCRIPTION OF THE DRAWINGS

FIG. 1: shows a section through a first embodiment of the bearing system.

FIG. 2: shows a section through a bearing system according to FIG. 1 having a slight modification of the magnetic axial bearing.

FIG. 3: shows a section through a further embodiment of the bearing system according to the invention.

FIG. 4: shows a section through an electric motor having a further embodiment of a bearing system according to the invention.

FIG. 5: shows a section through an electric motor having a further embodiment of a bearing system according to the invention.

FIG. 6: shows a section through a modification of the electric motor of FIG. 5.

FIG. 6A shows a section through an alternative embodiment of the rotor component of the electric motor from FIG. 6.

FIG. 6B shows a view from above of the rotor component from FIG. 6A.

FIG. 7 shows a section through an embodiment of the magnetic axial bearing having a first bearing part with a permanent magnet with U-shaped cross section.

FIG. 8 shows a section through an embodiment of the magnetic axial bearing having a first bearing part with a permanent magnet having an anisotropic magnetization.

FIG. 9 shows a section through an embodiment of the magnetic axial bearing, wherein both bearing parts consisting of a permanent magnet having an anisotropic magnetization.

### DESCRIPTION OF PREFERRED EMBODIMENTS OF THE INVENTION

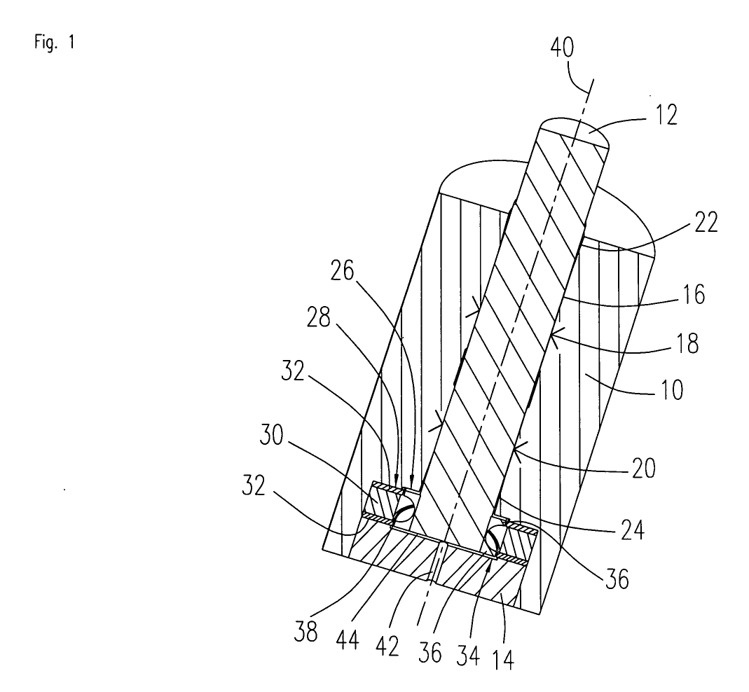

FIG. 1 shows a section through a first embodiment of a bearing according to the invention. The bearing consists of a bearing bush 10 that is given a substantially cylindrical shape and comprises a central bearing bore. At one end of the bearing bush 10, the central bearing bore widens out and forms a cylindrical recess having a larger diameter. A cylindrical shaft 12 is rotatably supported in the bore in the bearing bush 10, the outside diameter of the shaft 12 being slightly smaller than the inside diameter of the bearing bore. A bearing gap 16 filled with a bearing fluid thus remains between the outside diameter of the shaft 12 and the inside diameter of the bearing bush 10. The bearing gap 16 is open at both ends and each end is sealed against the environment by a sealing gap 22, 24. The sealing gaps 22, 24 are preferably formed as capillary seals and proportionally filled with bearing fluid. The sealing gaps 112, 14 moreover form a reservoir and expansion volume for the bearing fluid. Two radial bearings 18, 20 are preferably disposed along the bearing gap 16, the radial bearings 18, 20 being either designed as grooveless radial bearings having a corresponding smooth bearing surface, or having appropriate bearing grooves that generate fluid dynamic pressure in the bearing gap 16 through their pumping effect on the bearing fluid.

The axial bearing loads are taken up by a magnetic axial bearing 26 that is disposed at the lower end of the shaft 12 in the region of the recess in the bearing bush 10. The axial bearing 26 comprises a first axial bearing part 28 that is disposed at an inside circumference of the recess in the bearing bush 10. The first axial bearing part 28 consists of an annular permanent magnet whose north-south pole is aligned axially, i.e. in the direction of the rotational axis 40. At each of its axially aligned end faces, the permanent magnet 30 is covered by a flux conducting element 32 that is also annular in shape but whose inside diameter, however, is somewhat smaller than the inside diameter of the permanent magnet 30. At the inner circumferential surface, the flux conducting elements 32 thus protrude somewhat over the circumferential surface of the permanent magnet 30. Located radially inwards of the axial bearing part 28, a second axial bearing part 34 is disposed and separated from the first bearing part 28 by an air gap 38. The second axial bearing part 34 is annular in shape and attached at one end of the shaft. The second axial bearing part 34 comprises two flux conducting elements 36 spaced at a mutual distance from one another that lie opposite the flux conducting elements 32 of the first bearing part 28. These flux conducting elements 36 of the second axial bearing part form annular zones that define the largest outside diameter of the second bearing part in exactly the same way as the flux conducting elements 32 of the first axial bearing part form annular zones that define the smallest diameter of the first axial bearing part. The magnetic flux lines emanating from the permanent magnet 30 of the first axial bearing part 28 are concentrated in the flux conducting elements 32 and led in a radial direction via the air gap 38 and the flux conducting elements 36 of the second axial bearing part 34 back to the permanent magnet 30. An equilibrium of magnetic forces is produced. As soon as the shaft 12 is deflected with respect to the bearing bush 10 in an axial direction, i.e. in the direction of the rotational axis 40, the interaction of the permanent magnet 30 and flux conducting elements 32 and flux conducting elements 36 of the opposing bearing part generate a restoring force in an axial direction that keeps the shaft in stable levitation in an axial direction with respect to the bearing bush 10.

The permanent magnet 30 also attracts the second axial bearing part 34 in a radial direction, so that in addition to the axial stabilization, a radial preload of the fluid bearing occurs which reinforces the effect of the radial bearing 18, 20.

The flux conducting elements 32 that are disposed on the permanent magnet 30 are preferably made of ferromagnetic sheet metal having a thickness of some 0.2 mm or of a stack of laminations having a plurality of much thinner single metal sheets. The permanent magnet 30 is magnetized in an axial direction either unipolar or multipolar. To prevent the bearing bush from short-circuiting the magnetic flux, it is preferably made of a non-magnetic or soft magnetic material.

The magnetic axial bearing 26 is disposed outside the bearing gap 16 filled with bearing fluid, the parts of the bearing rotating with respect to each other being separated from one another by air gaps 38 or 44 that, compared to the bearing gap 16 filled with bearing fluid, can be made relatively large. The recess in the bearing bush 10 is covered by a covering plate 14 which goes to protect the axial bearing 26 against damage and to reduce the penetration of dirt into the bearing. An opening 42 is provided in the covering plate 14 that equalizes the pressure between the outside atmosphere and the recess in the bearing bush 10.

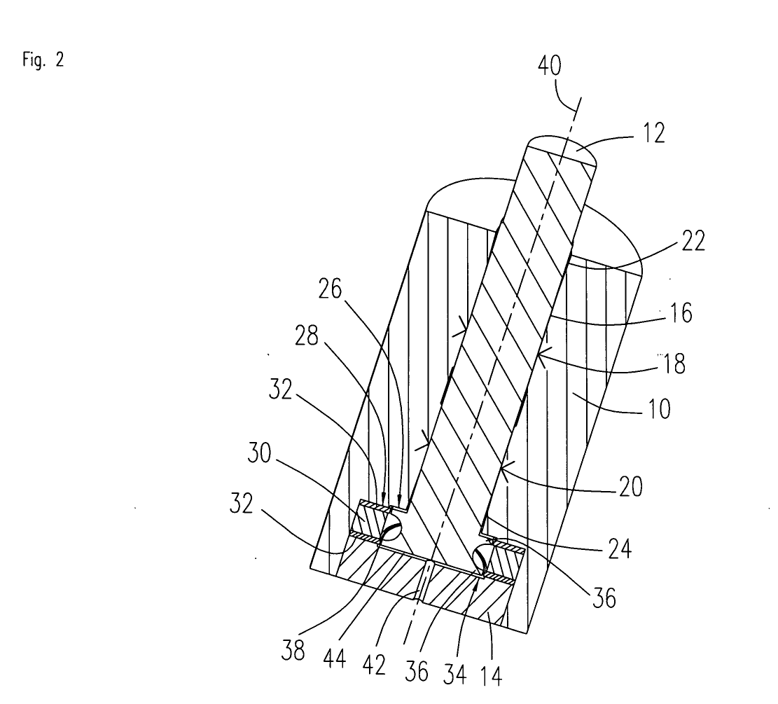

FIG. 2 shows a fluid dynamic bearing system according to the invention that is almost identical in design to the bearing system according to FIG. 1. The same reference numbers are used here and the description of the bearing according to FIG. 1 applies.

In contrast to the bearing system according to FIG. 1, in the bearing system according to FIG. 2 the second axial bearing part 34 is integrally formed with the shaft 12 as one piece. This means that separate machining of a second axial bearing part is now omitted as well as the assembly of the second axial bearing part 34 onto the shaft 12.

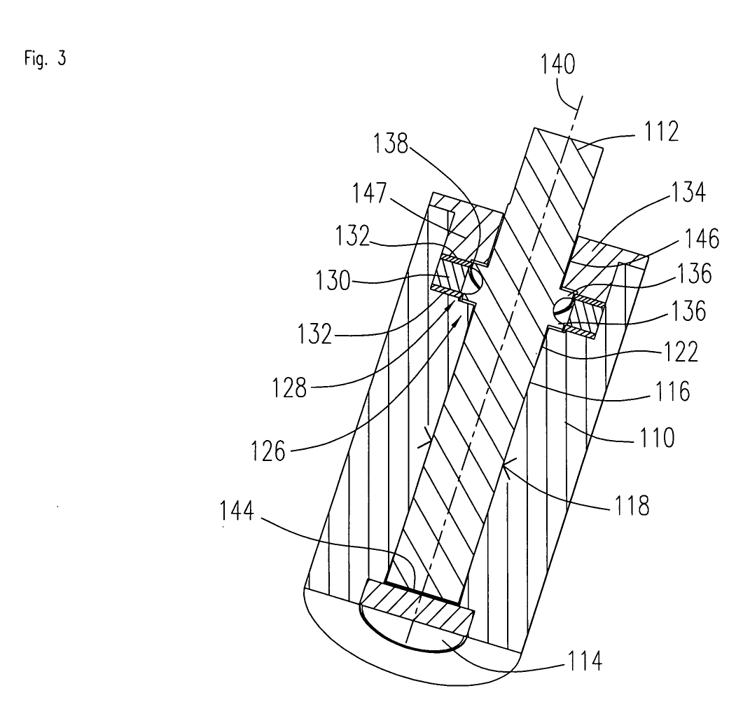

FIG. 3 shows a section through a fluid dynamic bearing system having a magnetic axial bearing that has approximately the same features as the bearing systems according to FIGS. 1 and 2 but has a different design and construction.

The bearing system comprises a bearing bush 110 in which a shaft 112 is rotatably supported. The bearing bush 110 and the shaft 112 are separated from one another by a bearing gap 116 filled with bearing fluid. The bearing bush 110 is sealed at one end by a covering plate 114 which simultaneously forms the termination of one end of the bearing gap 116. The bearing gap is thus only open at one end and sealed there by a sealing gap 122. A fluid dynamic radial bearing 118 is disposed along the bearing gap 116. Two radial bearing regions spaced at a distance from one another may also be provided. A gap 144 remains between the shaft 112 and the covering plate 114, the gap 144 being filled with bearing fluid and made relatively wide, so that this gap can be used as a fluid reservoir.

A magnetic axial bearing 126 absorbs the axial loads of the bearing system. The magnetic axial bearing 126 is not disposed at a lower end of the shaft 112 but rather in the region of the upper third of the shaft 116, above the bearing gap 116 and the sealing region 122. The axial bearing 126 is again disposed in a recess in the upper region of the bearing bush 110 and comprises a first axial bearing part 128 that is disposed at an inside circumference of the recess in the bearing bush 110. The first axial bearing part 128 comprises a permanent magnet 130 as well as two flux conducting elements 132 that are disposed on the end faces of the permanent magnet 130. The second axial bearing part 134, taking the form of two flux conducting elements 136 spaced at a distance from one another, is integrally formed with the shaft as one piece and separated by an air gap 138 from the first axial bearing part 128. The construction and the functioning of this magnetic axial bearing 126 correspond to the description of the bearing from FIG. 1. The recess in the bearing bush 110 is closed by a cover ring 147. The shaft 112 is led through a hole in the cover ring 147, an air gap 146 remaining between the outside diameter of the shaft 112 and the inside diameter of the cover ring 147, the air gap 146 ensuring pressure equalization between the surroundings and the recess in which the axial bearing 126 is disposed.

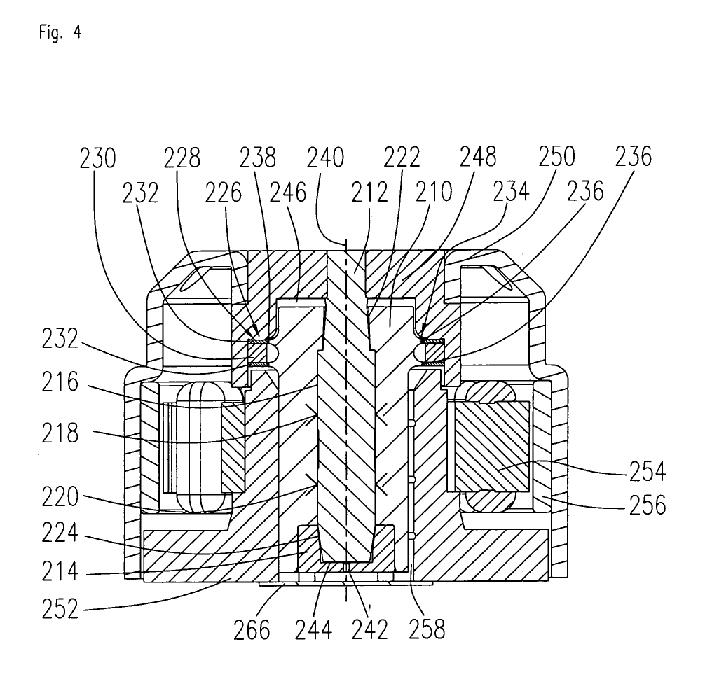

FIG. 4 shows a section through an electric motor having a further embodiment of a bearing system according to the invention that is particularly suited for use in a ventilator. The bearing system consists of an approximately cylindrical bearing bush 210 that is fixed in an opening in a baseplate 252 of the electric motor. The bearing bush 210 comprises a bearing bore in which a shaft 212 is rotatably supported. In the region of the bearing gap 216, the bearing bore and the shaft 212 are substantially cylindrical in shape, this gap region 216 being filled with bearing fluid. A sealing gap 222 adjoins the upper region of the bearing gap 216, the sealing gap 222 taking the form of a tapered sealing gap and being proportionally filled with bearing fluid. The bearing gap 216 merges into the sealing gap 222 while forming a radially inwards extending step. The step acts as a stopper element for the shaft 212 and limits any excessive axial movement of the shaft 212. The lower end of the bearing gap 216 also merges into a tapered sealing gap 224 that is formed by an end of the shaft 212 shaped approximately like a truncated cone and a cover 214 that is designed as a cup-shaped part and fitted into a recess in the bearing bush 210 and seals the bearing bush 210 from below. In the region of the bearing gap 216 filled with bearing fluid, two radial bearings 218 and 220 spaced at a distance from one another are provided. When in operation, great differences in pressure can occur at the top and bottom ends of the electric motor. To prevent these differences in pressure from having a negative effect on the fluid bearing, the sealing gap 224 is connected via an air gap 244, an opening 242 in the cover 214 and via a channel 258 to the upper region of the bearing. This goes to ensure that a similar level of pressure prevails at both ends of the bearing gap. A sealing film 266 seals the lower region of the bearing against the surroundings.

A free end of the shaft 212 protruding out of the bearing bush is connected to an approximately cup-shaped rotor component 248 of the electric motor. This rotor component 248 encloses the upper region of the bearing bush 210 and accommodates a magnetic axial bearing 226. The first axial bearing part 228 is disposed at an inside circumference of the rotor component 248 lying opposite the outside circumference of the bearing bush 210. The construction of the first axial bearing part 228 corresponds to the construction described in relation to the preceding embodiments and comprises a permanent magnet 230 that is set in two flux conducting elements 232. The second axial bearing part 234 consists of two flux conducting elements 236 spaced at a mutual distance from one another and preferably formed on the bearing bush 210 and that lie radially opposite the flux conducting elements 232 of the first axial bearing part 228 and being separated from this part by an air gap 238. The open end of the sealing gap 222 is connected to the surrounding atmosphere via an air gap 246.

The rotor component 248 carries a further rotor component 250 that is made, for example, from a deep-drawn, approximately cup-shaped sheet metal piece which encloses the rotor. This rotor component 250 carries a rotor magnet 256 which lies opposite a stator arrangement 254 that is disposed on the baseplate 252. Together with the rotor magnet 256, the stator arrangement 254 forms an electromagnetic drive system, such as is familiarly used in electric motors.

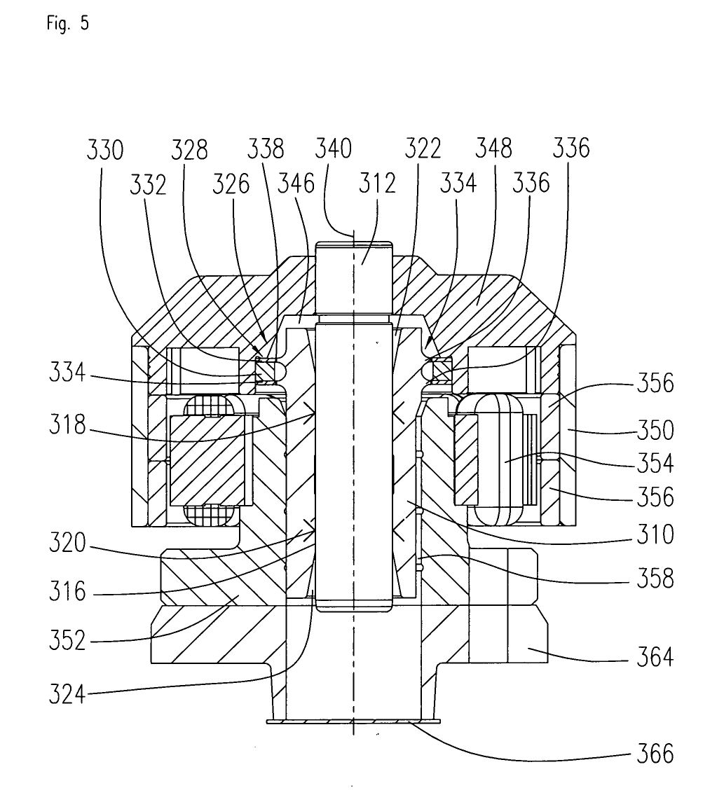

FIG. 5 shows a section through an electric motor having a modified embodiment of the bearing system. A shaft 312 is again rotatably supported about an axis 340 in a substantially cylindrical bearing bush 310. The bearing bush has a cylindrical bearing bore that widens to a taper at each end. A bearing gap 316 filled with bearing fluid is formed between the wall of the bearing bore and the outside circumference of the shaft 312, the bearing gap 316 being sealed at its ends by two sealing gaps 322 and 324. The sealing gaps 322, 324 are formed by the tapered widening of the bearing bore at the ends of the bearing bush 310 and have a tapered cross-section. Neither a stopper element nor a step is provided here between the shaft and the bearing bush 310 to act as a stopper for any excessive axial movement of the shaft. Nor is a cover provided for the open ends of the bearing bush 310.

The shaft 312 carries a first rotor component 348 at whose outside circumference a further cylindrical rotor component 350 is disposed, so that the two rotor components 348 and 350 enclose the bearing system to a large extent. The rotor component 348 has a recess in its inside circumference in which the magnetic axial bearing 326 is disposed. The construction and functioning of the magnetic axial bearing 326 correspond to that of the magnetic axial bearing 226 according to FIG. 4. The first bearing part 328 comprises a permanent magnet 330 as well as two flux conducting elements 332 that lie opposite a second bearing part 334 which likewise has two flux conducting elements 336 formed on the bearing bush 310.

On the baseplate 352 that holds the bearing bush 310, a stator arrangement 354 is fixed which is enclosed by a rotor magnet 356 that is disposed on the second rotor component 350. The baseplate 352 may be connected to a flange piece 364 that holds the motor. The cavity of the flange piece 364 can be connected to the cavity accommodating the axial bearing 326 via a channel 358. The channel 358 ensures an equalization of pressure at the two opposing ends of the bearing gap. The flange piece 364 is sealed with a sealing film 366.

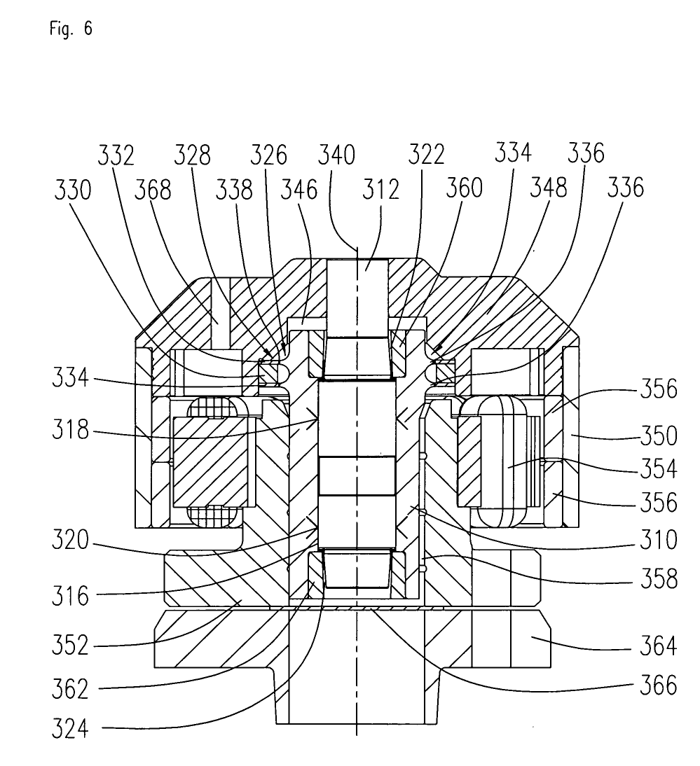

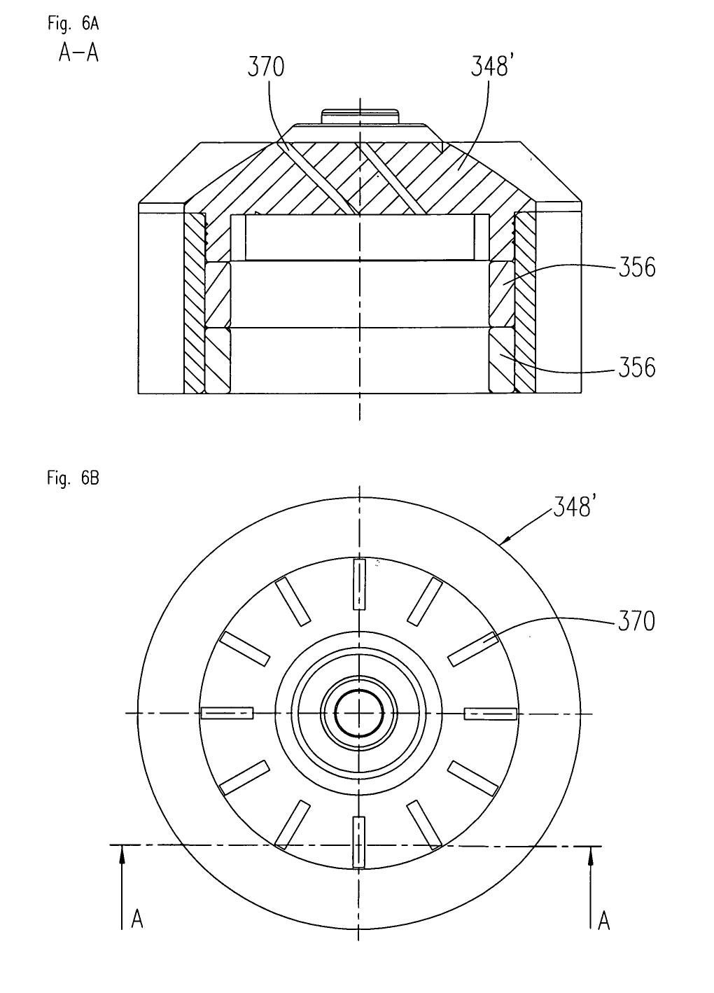

FIG. 6 shows an electric motor having a fluid dynamic bearing system that can be used, for example, for driving a fan wheel, which has the same features as the electric motor according to FIG. 5. In the case of the motor of FIG. 6, however, there are differences in the design of the shaft and the sealing regions of the bearing gap. The shaft 310 has tapered surfaces at the lower end and in an upper region facing the rotor component 348, these tapered surfaces forming the inner boundary of the sealing gaps 322 and 324. The bearing bush 310 is cylindrical in shape in the region of the bearing gap 316 and widens in the region of the sealing gaps 322 and 324 radially outwards in the form of a step and there again forms substantially cylindrical surfaces. Each outer boundary of the sealing gaps 322 and 324 is formed by an annular insert 360 or 362, the inserts being located in the widened recesses of the bearing bore. These annular inserts 360 and 362 simultaneously form stopper elements that strike against corresponding steps in the shaft 312 and prevent any axial displacement of the shaft 312 beyond the maximum permissible margin. To ensure efficient cooling of the motor at very high rotational speeds, the rotor component 348 has at least one cooling aperture 368 that is designed such that during the operation of a fan wheel, air is sucked in which then cools the electric motor. In other respects, the motor according to FIG. 6 is identical to the motor according to FIG. 5.

FIG. 6A shows an alternative embodiment of the rotor component 348′ that has slanted cooling channels 370 in the region of its outside circumference, the cooling channels 370 ensuring that the entire electric motor is adequately cooled at high rotational speeds. When the rotor component 348′ rotates clockwise, air is transported through the slanted cooling channels on the upper surface of the rotor component 348′ down to the lower surface and cools the electric drive system (shown in FIG. 6).

FIG. 6B shows the same rotor component as in FIG. 6A in a view from above. Here again the cooling channels 370 distributed about the circumference of the rotor component 348′ can be clearly seen.

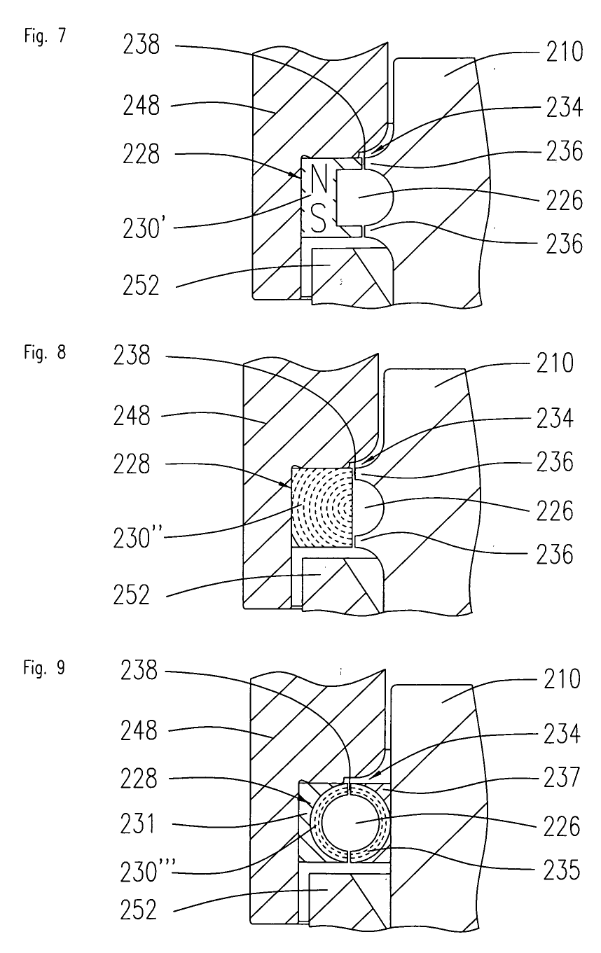

FIG. 7 shows a section through another embodiment of the magnetic axial bearing, similar to the bearing of FIG. 4. The magnetic axial bearing 226 comprises a first axial bearing part 228 disposed at an inside circumference of the rotor component 248. The first axial bearing part 228 is lying opposite the second axial bearing part that is located at the outside circumference of the bearing bush 210. The construction of the first axial bearing part 228 comprises a permanent magnet 230′ having a U-shaped cross section. The legs of the U-shaped permanent magnet 230′ defining the poles of the magnet 230′ are directed towards the second axial bearing part 234. The second axial bearing part 234 consists of two flux conducting elements 236 spaced at a mutual distance from one another and preferably formed on the bearing bush 210. The flux conducting elements lie radially opposite the legs of the permanent magnet 230′ of the first axial bearing part 228 and being separated from this part by an air gap 238.

FIG. 8 shows a section through a further embodiment of the magnetic axial bearing, similar to the bearing structure of FIG. 7. Different to FIG. 7, the first axial bearing part 228 comprises a permanent magnet 230″ having for example a rectangular cross section. The permanent magnet 230″ has an anisotropic magnetization, the magnetic field lines are directed towards the flux conducting elements 236 of the second axial bearing part 234. The construction of the second axial bearing part 234 is identical to FIG. 7.

FIG. 9 shows a section through still a further embodiment of the magnetic axial bearing, similar to the bearing structure of FIG. 7. Different to FIG. 7, both, the first 228 and the second axial bearing 234 parts consist of a permanent magnet 230′″ and 235, respectively. The permanent magnets 230′″ and 235 have for example a curved cross section and an anisotropic magnetization. The magnetic field lines of the permanent magnets 230′″ and 235 are directed to each other. The permanent magnet 230′″ of the first axial bearing part 228 is fixed in a mounting support 231 which it is attached to the rotor component 248. The permanent magnet 235 of the second axial bearing part 234 is fixed to the bearing bush 210 by means of a mounting support 237.

### IDENTIFICATION REFERENCE LIST

10, 110 Bearing bush
12, 122 Shaft
14, 114 Covering plate
16, 116 Bearing gap
18, 118 Radial bearing
20 Radial bearing
22, 122 Sealing gap
24 Sealing gap
26, 126 Axial bearing
28, 128 First axial bearing part
30, 130 Permanent magnet
32, 132 Flux conducting element
34, 134 Second axial bearing part
36, 136 Flux conducting element
38, 138 Air gap
40, 140 Rotational axis
42 Opening
44, 144 Gap
146 Air gap
147 Cover ring
210, 310 Bearing bush
212, 312 Shaft
214 Cover
216, 316 Bearing gap
218, 318 Radial bearing
220, 320 Radial bearing
222, 322 Sealing gap
224, 324 Sealing gap
226, 326 Axial bearing
228, 328 First axial bearing part
230, 330 Permanent magnet
230′, 230″, 230′″
231 Mounting support
232, 332 Flux conducting element
234, 334 Second axial bearing part
235 Permanent magnet
236, 336 Flux conducting element
237 Mounting support
238, 338 Air gap
240, 340 Rotational axis
242 Opening
244 Gap
246, 346 Air gap
248, 348, Rotor component
348′
250, 350 Rotor component
252, 352 Baseplate
254, 354 Stator arrangement
256, 356 Rotor magnet
358 Channel
360 Annular insert
362 Annular insert
364 Flange piece
266, 366 Sealing film
368 Cooling aperture
370 Cooling rib

1. A fluid dynamic bearing system for the rotatable support of an electric motor that comprises,
a substantially cylindrical bearing bush (10; 110; 210; 310) having a bearing bore,
a shaft (12; 112; 212; 312) rotatably supported about a rotational axis (40; 140; 240; 340) accommodated in the bearing bore,
a bearing gap (16; 116; 216; 316) formed between mutually adjacent surfaces of the bearing bush (10; 110; 210; 310) and the shaft (12; 112; 212; 312) that is filled with a bearing fluid and extends in an axial direction parallel to the rotational axis (40; 140; 240; 340),
at least one radial bearing (18; 118; 218; 318; 20; 220; 320) that is disposed along the bearing gap (16; 116; 216; 316) and formed by bearing surfaces of the bearing bush (10; 110; 210; 310) and the shaft (12; 112; 212; 312), and
at least one axial bearing (26; 126; 226; 326) that is formed as a magnetic bearing.

2. A fluid dynamic bearing system according to claim 1, characterized in that the axial bearing (26; 126) is disposed in axial extension of the bearing gap (16; 116).

3. A fluid dynamic bearing system according to claim 1, characterized in that the axial bearing (26; 126; 226; 326) is disposed radially outwards of and on a larger diameter than the radial bearing (18; 118; 218; 318; 20; 120; 220; 320)

4. A fluid dynamic bearing system according to claim 1, characterized in that the axial bearing (26; 126; 226; 326) comprises a first axial bearing part (28; 128; 228; 328) that consists of at least one permanent magnet (30; 130; 230; 330) and at least two flux conducting elements (32; 132; 232; 332) associated with the permanent magnet (30; 130; 230; 330) that are disposed on opposing end faces of the permanent magnet (30; 130; 230; 330) and aligned substantially radial and perpendicular to the rotational axis (40; 140; 240; 340).

5. A fluid dynamic bearing system according to claim 1, characterized in that the axial bearing (26; 126; 226; 326) comprises a second axial bearing part (34; 134; 234; 334) that consists of at least two flux conducting elements (36; 136; 236; 336) that are disposed at a mutual distance from one another and aligned substantially radial and perpendicular to rotational axis (40; 140; 240; 340).

6. A fluid dynamic bearing system according to claim 4, characterized in that each flux conducting element (36; 136; 236; 336) of the second axial bearing part (34; 134; 234; 334) is associated with a flux conducting element (32; 132; 232; 332) of the first axial bearing part (28; 128; 228; 328) and lies directly opposite the latter in a radial direction separated by an air gap (38; 138; 238; 338).

7. A fluid dynamic bearing system according to claim 5, characterized in that the second axial bearing part (34; 134) is disposed on a circumferential section of the shaft (12; 112), and that the first axial bearing part (28; 128) is disposed in a recess in the bearing bush (10; 110) and radially encloses the second axial bearing part (34; 134) while forming the air gap (38; 138).

8. A fluid dynamic bearing system according to claim 5, characterized in that the second axial bearing part (34) is disposed at one end of the shaft (12).

9. A fluid dynamic bearing system according to claim 5, characterized in that the second axial bearing part (34) is integrally formed with the shaft (12) as one piece.

10. A fluid dynamic bearing system according to claim 5, characterized in that the second axial bearing part (34; 134) is formed as a stopper element of the shaft (12; 112).

11. A fluid dynamic bearing system according to claim 5, characterized in that the second axial bearing part (234; 334) is disposed at an outer circumferential section of the bearing bush (210; 310), and the first axial bearing part (228; 328) is disposed in a recess in a rotor component (248; 348; 348′) connected to the shaft (212; 312) and radially encloses the second axial bearing part (234; 334) while forming the air gap.

12. A fluid dynamic bearing system according to claim 11, characterized in that the second axial bearing part (234; 334) is integrally formed with the bearing bush (210; 310) as one piece.

13. A fluid dynamic bearing system according to claim 1, characterized in that the axial bearing (226) comprises a first axial bearing part (228) that consists of at least one permanent magnet (230′).

14. A fluid dynamic bearing system according to claim 1, characterized in that the axial bearing (226) comprises a second axial bearing part (234) that consists of at least a one permanent magnet (235).

15. A fluid dynamic bearing system according to claim 1, characterized in a rotor component (348; 348′) attached to the shaft (312), the rotor component (348; 348′) has one or more cooling apertures (368) or cooling slots (370).

16. A fluid dynamic bearing system according to claim 1, characterized in that the bearing gap (16; 216; 316) has two open ends each of which is sealed by a sealing gap (22, 222; 322; 24; 224; 324), the sealing gaps (22, 222; 322; 24; 224; 324) being disposed in axial extension of the bearing gap (16; 216; 316).

17. A fluid dynamic bearing system according to claim 1, characterized in that the bearing gap (116) has an open end that is sealed by a sealing gap (122) running in axial extension of the bearing gap, and a closed end that is closed by the bearing bush (110) or a part (114; 266; 366) covering the bearing bush.

18. A fluid dynamic bearing system according to claim 16, characterized in that, starting from the bearing gap (16; 116; 216; 316), the cross-section of the sealing gap (22, 222; 322; 24; 224; 324) widens to a taper.

19. A fluid dynamic bearing system according to claim 16, characterized in that the sealing gap (222; 322; 224; 324) runs at an acute angle to the rotational axis (240; 340) and has an open end, the section of the sealing gap (222; 322; 224; 324) adjacent to the bearing gap (216; 316) having a larger diameter than the open end of the sealing gap (222; 322; 224; 324).

20. A fluid dynamic bearing system according to claim 19, characterized in that a channel (258; 358) runs within the bearing bush that connects the sealing gaps (222; 322; 224; 324) to each other and ensures the equalization of pressure between the sealing gaps (222; 322; 224; 324).

21. A fluid dynamic bearing system according to claim 1, characterized in that the at least one radial bearing (18; 118; 218; 318; 20; 120; 220; 320) has bearing grooves that are disposed on the bearing surface of the bearing bush (10; 110; 210; 310) and/or the bearing surface of the shaft (12; 112; 212; 312).

22. A fluid dynamic bearing system according to claim 1, characterized in that the at least one radial bearing (18; 118; 218; 318; 20; 120; 220; 320) is formed as a grooveless radial bearing.

23. A fluid dynamic bearing system according to claim 1, characterized in that the at least one radial bearing (18; 118; 218; 318; 20; 120; 220; 320) is formed as a segment thrust bearing or multi-face slide bearing.

24. An electric motor having a stator and a rotor that is rotatably supported with respect to the stator by means of a bearing system according to claim 1, and an electromagnetic drive system.

25. An electric motor according to claim 24 having a rotor component (348, 348′) that has means (368, 370) for cooling the electric motor.
